(19) United States
(12) Patent Application Publication
(10) Pub. No.: US 2007/0151448 A1
(43) Pub. Date: Jul. 5, 2007

(54) Discharge electrode and method for enhancement of an electrostatic precipitator

(76) Inventors: Robert Taylor, Overland Park, KS (US); Abdelkrim Younsi, Ballston Lake, NY (US); Yingneng Zhou, Niskayuna, NY (US); David Johnston, Poquoson, VA (US); Terry Farmer, Kearney, MO (US); J. Easel Roberts, Kansas City, MO (US)

Correspondence Address: CANTOR COLBURN, LLP, 55 GRIFFIN ROAD SOUTH, BLOOMFIELD, CT, 06002, US

(21) Appl. No.: 11/326,306

(22) Filed: Jan. 4, 2006

(51) Int. Cl. B03C 3/41

(52) U.S. Cl. 95/57; 95/78; 96/95; 96/97

(57) ABSTRACT

Apparatus and method for producing an electrostatic precipitator that includes a discharge electrode having an enhanced design, the enhanced design for improving an electric field and particulate collection efficiency within the electrostatic precipitator.

### BACKGROUND OF THE INVENTION

This invention relates generally to electrostatic precipitators, and more specifically to techniques for improving the collection efficiency thereof.

Many industrial facilities require devices for limiting environmental emissions of particulate materials. A well-known device is the electrostatic precipitator. Electrostatic precipitators are commonly used in the electric utility industry at power production facilities (to limit emission of combustion by-products). Other examples of industries using electrostatic precipitators include those fabricating cement (dust), pulp and paper products (salt cake and lime dust), petrochemicals (for various mists), and steel (dust and fumes).

Electrostatic precipitators direct a stream of particle-laden gases through a collector chamber. The collector chamber contains electrodes that act as particle collectors. In a typical design, discharge electrodes are electrically insulated from the rest of the chamber and charged electrically. The electrical charge ionizes the suspended particles, causing them to move toward the collecting electrodes. A variety of collection devices may be employed to trap and remove the particles from the stream.

In the electrostatic precipitator, particles become negatively charged as a result of the negative discharge corona generated at the discharge electrode. The corona occurs when high voltage is applied to the discharge electrode. The precipitating process results from two simultaneous events: charging of the particles or co-mingling of the particles with other charged particles and attracting of charged particles under the applied electric field.

Electrostatic precipitators typically have a high efficiency rating. However, in some instances, electrostatic precipitators do not work as well as is desired. For example, electrostatic precipitators are not as effective with discharge streams having particles with a high electrical resistivity. Further challenges to the efficiency arise as users increase flow rates through the collection chamber in order to meet increased production (discharge) needs.

What is needed is a technique to improve the collection efficiency of an electrostatic precipitator. Preferably, this is accomplished through optimization of the discharge electrode geometry without increasing the available collecting plate area.

### BRIEF DESCRIPTION OF THE INVENTION

The above discussed and other drawbacks and deficiencies are overcome or alleviated by the teachings herein, wherein an improved electrostatic precipitator, a discharge electrode and a method are disclosed.

The discharge electrode for the electrostatic precipitator includes geometric features incorporated into the discharge electrode and adapted according to an algorithm for improving collection efficiency for particles by enhancing an electric field between the discharge electrode and a collection electrode of the electrostatic precipitator.

The method for producing a discharge electrode for an electrostatic precipitator includes stages for selecting an algorithm for evaluation of the collection efficiency of the electrostatic precipitator; and incorporating geometric features into the discharge electrode according to the algorithm, wherein the geometric features improve the collection efficiency by enhancing the charging and collecting electric field between the discharge electrode and the collection electrode of the electrostatic precipitator.

The electrostatic precipitator includes at least one discharge electrode having geometric features incorporated into the discharge electrode and adapted according to an algorithm for improving collection efficiency for particles by enhancing an electric field between the discharge electrode and the collection electrode of the electrostatic precipitator.

The above-discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several Figures:

FIG. 1 depicts aspects of an electrostatic precipitator with a V-Pin discharge electrode;

FIG. 2 depicts aspects of a quad blade discharge electrode;

FIG. 3-1 and FIG. 3-2, collectively referred to as FIG. 3, depict aspects of the discharge electrode and the stiffener, respectively;

FIG. 4 depicts aspects of the V-Pin discharge electrode;

FIG. 5-1 and FIG. 5-2, collectively referred to as FIG. 5, depicts a dual blade discharge electrode;

FIG. 6-1 and FIG. 6-2, collectively referred to as FIG. 6, depicts a quad blade discharge electrode;

FIG. 7-1 and FIG. 7-2, collectively referred to as FIG. 7, depicts an angle configuration discharge electrode;

FIG. 8-1 and FIG. 8-2, collectively referred to as FIG. 8, depicts a star configuration discharge electrode;

FIG. 9-1 and FIG. 9-2, collectively referred to as FIG. 9, depicts an aero configuration discharge electrode;

FIG. 10-1 and FIG. 10-2, collectively referred to as FIG. 10, depicts a roll formed discharge electrode; and,

FIG. 11-1 and FIG. 11-2, collectively referred to as FIG. 1, depicts a quad pin discharge electrode.

### DETAILED DESCRIPTION THE INVENTION

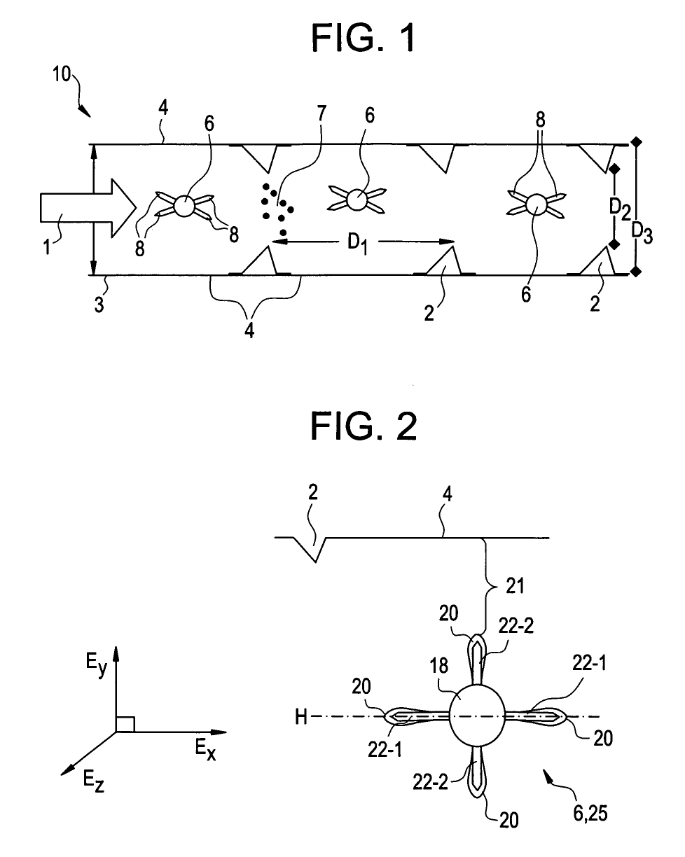

Referring to FIG. 1, there is shown an exemplary embodiment of an electrostatic precipitator 10 including improvements as disclosed herein. The electrostatic precipitator 10 is typically a planar structure that includes a series of parallel and generally flat collecting plates 4 more or less evenly spaced, with discharge electrodes 6 located periodically between the collecting plates 4. Typically included in the electrostatic precipitator 10 are a series of stiffeners 2. During operation, collecting plates 4 attract and collect particles 7 entrained in the emission gas 1. As is known in the art, a high voltage is applied across the discharge electrodes 6 and the collecting plates 4 to generate an electric field. Once in the electric field, the particles 7 generally become negatively charged and migrate toward the collecting plates 4 (also referred to as “collecting electrodes 4”). This migration occurs, at least in part, as a result of the negative discharge corona (not shown) generated at the discharge electrode 6.

As used herein, the term “particles” refers to any material, or materials, entrained in a gas, fume or other media for which an electrostatic precipitator 10 may be used to reduce the concentrations thereof. Accordingly, as used herein, particles 7 should be considered to be a general and non-limiting term. For example, particles 7 maybe included in materials that might be classified as one of dust, fumes, gas and a mist.

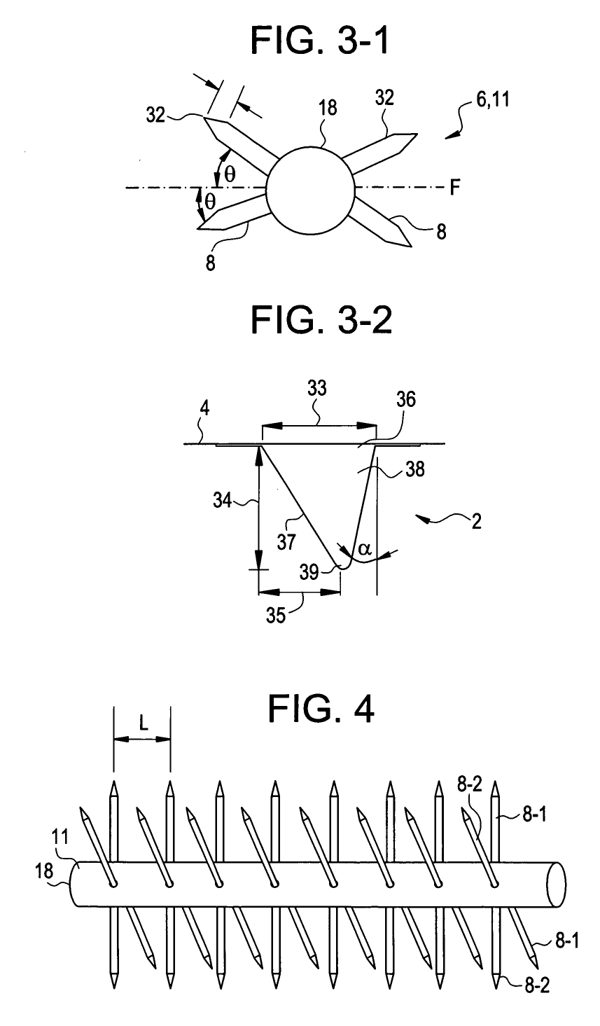

In FIG. 1, the discharge electrode 6 has been enhanced with a series of pins 8. In the embodiment depicted, each discharge electrode 6 includes four series of the pins 8. This configuration of the discharge electrode 6 is discussed later herein with greater detail in reference to FIG. 3

Selecting dimensions of the pins 8 is one example of selecting physical aspects of the discharge electrode 6 in order to manipulate the electric field and thus improve the collection efficiency of the electrostatic precipitator 10. That is, when voltage is applied to the discharge electrode 6, the pins 8 provide for generation of an electric field having properties that result in improved collection efficiency. It should be noted that aside from the improving collection efficiency, this benefit does not require increasing the area of the collecting plates 4.

Aside from modifying aspects of the discharge electrode 6, a variety of dimensions may be modified to assist with improving the collection efficiency. Exemplary dimensions that may be varied include, without limitation, the distance between the stiffeners 2, (shown as D₁ and referred to as the “stiffener spacing”); the gas passing width D₃; the baffle spacing D₂; and, the shape and size (including varying height and width ratios) of the stiffeners 2. Further aspects of the electrostatic precipitator 10 that may be varied include placement of features such as the stiffeners 2 in relation to the discharge electrode 6. In short, any other aspects of the geometry and relationships of features of the electrostatic precipitator 10 may be varied in conjunction with the design of the discharge electrode 6 to provide for improved collection efficiency.

In order to better characterize improvements to the collection efficiency, it is important to understand certain relationship. Increases in migration velocity result in large changes in the collection efficiency of the particles 7. This relationship is described by the algorithm given generally in Equation 1 (referred to as the “Deutsch Anderson” equation):
η=1−e^{(-A/Q)ω} (Eq. 1)
wherein
η represents the collection efficiency;
   ω represents the particle migration velocity;
A represents the area of the collection electrode; and,
Q represents the flow rate of the gas.

Migration velocity is further defined as:
ω=(EₒEₚa)/(2πh) (Eq. 2)
wherein
ω represents the particle migration velocity (typically in meters/second);
Eₒ represents the charging electric field (typically in volts/meter);
Eₚ represents the collecting electric field (typically in volts/meter);
a represents the particle size (typically in meters);
π represents a constant, pi, having a value of approximately 3.14; and,
h represents the viscosity of the gas (typically in kilograms/meters-seconds).

Note that Equation 2 describes aspects of particle 7 migration in a uniform electric field. For cases of non-uniform electric fields, such as those encountered in a duct-type of electrostatic precipitator 10, Eₒ and Eₚ are defined according to Equation 3 and Equation 4, respectively.
Eₒ=Average(\sqrt{Eₓ²+E_{y}²+E_{z}²}) (Eq. 3)
Eₚ=Average(\sqrt{Eₓ²+E_{y}²}) (Eq. 4);
where, for small stiffeners 2,
Eₚ=Average(|E_{y}|) (Eq. 5);
wherein:
Eₓ represents the average electric field in the X direction;
E_{y} represents the average electric field in the Y direction;
E_{z} represents the average electric field in the Z direction; and,
Average represents the average value over the entire space between the discharge electrode 6 and the collecting plates 4.

These relationships can be simplified and better understood, when considered in conjunction with the embodiment depicted in FIG. 2. The embodiment of the discharge electrode 6 depicted in FIG. 2 is referred to as a “quad blade electrode 25.” For the quad blade electrode 25, strips of metal 22 were applied along the surface of a round tube 18 to create the discharge electrode 6. The strips of metal 22 were each offset about 90 degrees from the other strips of metal 22. Two of the strips of metal, referred to herein for convenience as “major strips 22-1” were generally greater in size than the “minor strips 22-2.” The major strips 22-1 were placed in parallel with the general flow of the emission gas 1.

In the embodiment depicted, each of the strips of metal 22 includes a small region that is referred to as the high field region 20. In this embodiment, the charging region 20 is the region where the electric field is typically higher than 30 kV/cm. Also depicted in FIG. 2 is the low field region 21, where the electric field is typically lower than 30 kV/cm. In some embodiments, the small region of the strips of metal 22 is sharpened (e.g., to a knife-edge) to provide for improved corona.

FIG. 3-1 and FIG. 3-2, collectively referred to as FIG. 3, provide a more detailed example of improvements to the discharge electrode 6. This embodiment, referred to as a V-Pin electrode 11. In the non-limiting embodiment depicted in FIG. 3-1, each of the pins 8 is about 1.5 inches (3.81 cm) in overall length. In this example, the cross section of each of the pins 8 is of a round appearance, and about 0.134 inches (0.34 cm) in diameter. Further, each pin 8 depicted includes a pointed tip 32. In this embodiment, the pointed region of the tip 32 is about 0.1875 inches (0.48 cm) in length, as depicted by the dimensional arrows in FIG. 3-1. In this embodiment, the round tube 18 at the center of the V-Pin electrode 11 is about 1.5 inches (3.81 cm) in diameter. In the embodiment depicted of the V-Pin electrode 11, the series of pins 8 are offset at an angle theta (θ) from a plane F bisecting the V-Pin electrode 11 and consistent with the direction of flow. In this example, the offset angle theta (θ) is substantially less than 90 degrees and closer to about 30 degrees.

Referring also to FIG. 3-2, shape and size of the stiffener 2 may be modified to improve the collection efficiency of the electrostatic precipitator 10. As one example, for the V-Pin electrode 11 depicted in FIG. 3-1, the stiffener 2 includes a base 36, a forward side 38, a stiffener tip 39 and an aft side 37. The stiffener tip 39 is located at an angle alpha (α) of about four degrees aft of the base 36 on the forward side 38. The base 36 on the aft side 37 about 2.7 inches (6.7 cm) aft of the stiffener tip 39. The overall height of the stiffener 2 (distance of the stiffener tip 39 from the base 36) is about 1.9 inches (4.826 cm).

In some embodiments, the V-Pin electrode 11 is located about halfway between each discharge electrode 6, and about halfway between each stiffener 2, as depicted in FIG. 1. For the embodiment presented in FIG. 3, each stiffener 2 is about 18.875 inches (47.93 cm) apart, when measured from stiffener tip 39 to next successive stiffener tip 39. Also for this embodiment, the gas passing width D₃ is about 11 inches (27.94 cm).

Referring also to FIG. 4, further dimensions related to this embodiment include the lateral spacing L of the pins 8 along the rounded tube 18. In this example, the lateral spacing L of the pins 8 is about 3 inches (7.62 cm), while the distance between the base of a first pin 8-1 from a second pin 8-2 in each V is about 0.5 inches (1.27 cm) along the circumference of the rounded tube 18.

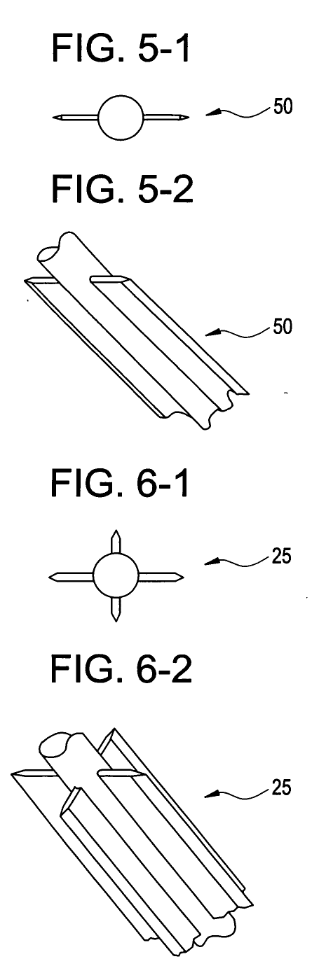

It should be noted that the V-Pin electrode 11 and the quad blade electrode 25 are only two of the many other embodiments for the discharge electrode 6. Other exemplary embodiments are depicted in FIGS. 5-11.

Referring to FIG. 5-1 and FIG. 5-2, collectively referred to as FIG. 5, there is shown a dual blade electrode 50. FIG. 5-1 depicts a cross section of the dual blade electrode 50, while FIG. 5-2 provides an angular view of the dual blade electrode 50.

Referring to FIG. 6-1 and FIG. 6-2, collectively referred to as FIG. 6, there is shown the quad blade electrode 25. FIG. 6-1 depicts a cross section of the quad blade electrode 25, while FIG. 6-2 provides an angular view of the quad blade electrode 25.

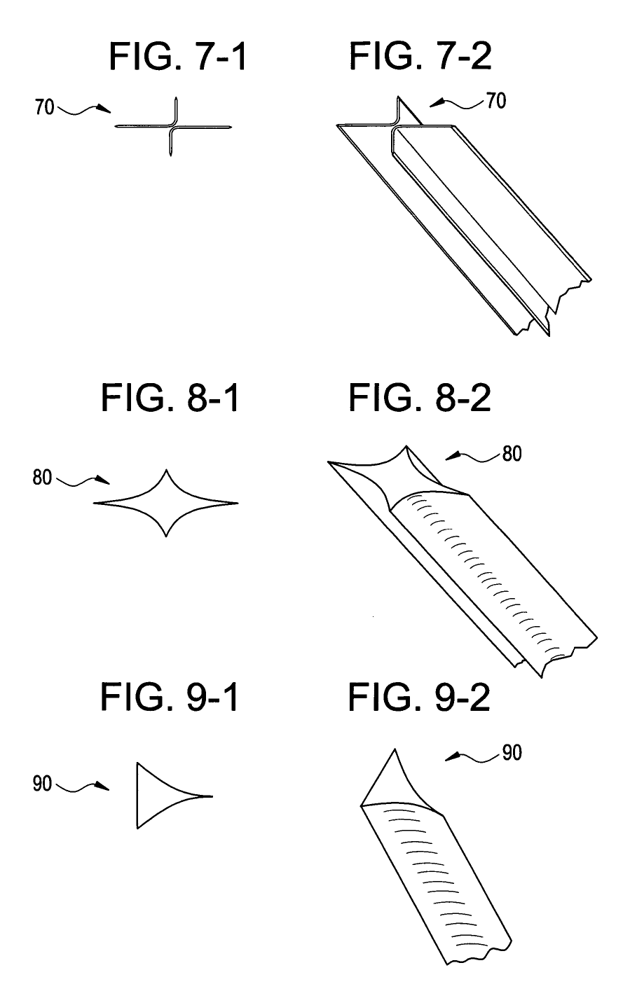

Referring to FIG. 7-1 and FIG. 7-2, collectively referred to as FIG. 7, there is shown an angle configuration electrode 70. FIG. 7-1 depicts a cross section of the angle configuration electrode 70, while FIG. 7-2 provides an angular view of the angle configuration electrode 70. Note that the angle configuration electrode 70 does not include the round tube 18.

Referring to FIG. 8-1 and FIG. 8-2, collectively referred to as FIG. 8, there is shown a star configuration electrode 80. FIG. 8-1 depicts a cross section of the star configuration electrode 80, while FIG. 8-2 provides, an angular view of the star configuration electrode 80. Note that the star configuration electrode 80 does not include the round tube 18.

Referring to FIG. 9-1 and FIG. 9-2, collectively referred to as FIG. 9, there is shown an aero configuration electrode 90. FIG. 9-1 depicts a cross section of the aero configuration electrode 90, while FIG. 9-2 provides an angular view of the aero configuration electrode 90. Note that the aero design electrode 90 does not include the round tube 18.

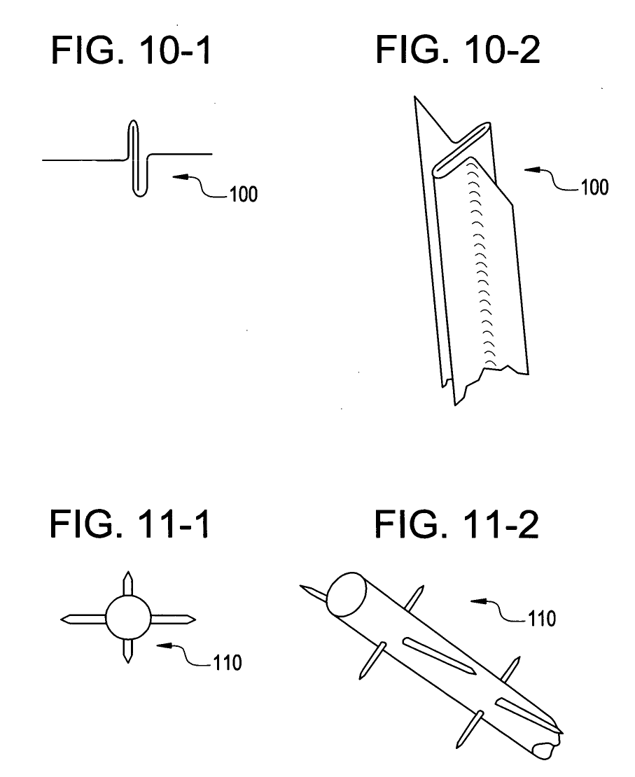

Referring to FIG. 10-1 and FIG. 10-2, collectively referred to as FIG. 10, there is shown a roll formed configuration electrode 100. FIG. 10-1 depicts a cross section of the roll formed configuration electrode 100, while FIG. 10-2 provides an angular view of the roll formed configuration electrode 100. Note that the roll formed configuration electrode 100 does not include the round tube 18.

Referring to FIG. 11-1 and FIG. 11-2, collectively referred to as FIG. 11, there is shown a quad pin electrode 110. FIG. 11-1 depicts a cross section of the quad pin electrode 110, while FIG. 11-2 provides an angular view of the quad pin electrode 110.

In summary, one can generally refer to these non-limiting examples of improved discharge electrodes 6 as having “features” that improve the particle 7 migration velocity (ω). As taught herein, these features provide for improved electric field properties across the migration space 21.

Accordingly, it should be obvious to one skilled in the art that the features may be attached to existing aspects of the discharge electrode 6 (for example, the round tube 18 as a retrofit to existing technology), may replace existing discharge electrodes 6 entirely (for example, during a system overhaul), or may be used in addition to existing discharge electrodes 6. Of course, design of the electrostatic precipitator 10 may take advantage of the teachings herein to provide for an improved electric field and, thus, modify other aspects of the electrostatic precipitator 10. For example, the size, shape and placement of the stiffeners 2 may be considered and designed to work in conjunction with the discharge electrode 6 incorporating such features.

Calculations performed in accordance with the techniques provided herein (Eq. 1) show that increasing the value of (Eₒ*Eₚ) will increase the migration velocity (ω). Using the techniques provided, one can see that the collection efficiency (η) is exponentially related to the migration velocity (ω). Data obtained in the laboratory has shown that significant increases in the value of (Eₒ*Eₚ) may be achieved for varying configurations. In particular, of the embodiments evaluated in the laboratory, it was noted that the quad blade electrode 25 provided for substantial improvements in collection efficiency (η). A summary of the results is provided in Table 1.

TABLE 1
Summary of Efficiency Testing

| | | | | | |
|---|---|---|---|---|---|
| | | | | Minor | Migration |
| | Tube | Pin | Stiffener | blade | indicator |
| | diameter | length | distance | length | (Eₒ * Eₚ) |
| Case | (inches) | (inches) | (inches) | (inches) | (V²/m²) |

10 inch gas passage width, D₃

| | | | | | |
|---|---|---|---|---|---|
| Q-10 | 2 | 2 | 15.9 | 1 | 3.01 |
| D-25 | 2 | 2 | 15.9 | 0 | 2.87 |
| Q-3 | 1 | 2 | 15.9 | 1 | 2.42 |
| O-25 | 2 | 2 | 15.9 | 0 | 1.98 |
| V-19 | 2 | 1 | 15.9 | 0 | 1.75 |
| Q-41 | 2 | 2 | 21.9 | 1 | 1.71 |
| V-18 | 1 | 2 | 15.9 | 0 | 1.61 |
| Q-23 | 1 | 2 | 21.9 | 1 | 1.38 |
| O-18 | 1 | 2 | 15.9 | 0 | 1.37 |
| V-22 | 2 | 2 | 21.9 | 0 | 1.25 |
| O-22 | 2 | 2 | 21.9 | 0 | 1.04 |
| O-21 | 2 | 1 | 21.9 | 0 | 0.94 |
| V-3 | 1 | 2 | 21.9 | 0 | 0.91 |
| O-3 | 1 | 2 | 21.9 | 0 | 0.69 |

11 inch gas passage width, D₃

| | | | | | |
|---|---|---|---|---|---|
| D-4 | 1.5 | 1.5 | 15.9 | 0 | 1.89 |
| Q-19 | 1.5 | 2 | 18.9 | 0.75 | 1.74 |
| Q-27 | 1.5 | 1.5 | 18.9 | 1 | 1.52 |
| V-4 | 1.5 | 1.5 | 15.9 | 0 | 1.47 |
| Q-26 | 1.5 | 1.5 | 18.9 | 0.5 | 1.45 |
| O-4 | 1.5 | 1.5 | 15.9 | 0 | 1.35 |
| V-20 | 1.5 | 2 | 18.9 | 0 | 1.26 |
| D-11 | 1.5 | 1 | 18.9 | 0 | 1.18 |
| O-20 | 1.5 | 2 | 18.9 | 0 | 1.11 |
| V-23 | 1.5 | 1.5 | 18.9 | 0 | 1.10 |
| O-23 | 1.5 | 1.5 | 18.9 | 0 | 1.00 |
| V-1 | 1.5 | 1.5 | 21.9 | 0 | 0.84 |

12 inch gas passage width, D₃

| | | | | | |
|---|---|---|---|---|---|
| Q-1 | 2 | 2 | 15.9 | 1 | 2.29 |
| Q-32 | 2 | 2 | 15.9 | 0.5 | 2.22 |
| D-25 | 1 | 2 | 15.9 | 0 | 1.77 |
| V-10 | 2 | 2 | 15.9 | 0 | 1.73 |
| O-10 | 2 | 2 | 15.9 | 0 | 1.57 |
| Q-36 | 2 | 2 | 21.9 | 1 | 1.35 |
| Q-13 | 2 | 2 | 21.9 | 0.5 | 1.31 |
| V-2 | 1 | 2 | 15.9 | 0 | 1.30 |
| D-17 | 2 | 2 | 21.9 | 0 | 1.29 |
| O-2 | 1 | 2 | 15.9 | 0 | 1.11 |
| V-17 | 2 | 2 | 21.9 | 0 | 1.01 |
| V-15 | 1.5 | 1.5 | 18.9 | 0 | 1.00 |
| O-17 | 2 | 2 | 21.9 | 0 | 0.86 |

Note that in Table 1, the embodiment used in each case is signified by an alphabetic identification. That is, D indicates evaluation of the dual blade electrode 50, Q indicates evaluation of the quad blade electrode 25, and V indicates evaluation of the V-Pin electrode 11. O indicates evaluation of a standard (prior art) opposed pin discharge electrode. Note that in Table 1, a value of 1.00 for (Eₒ*Eₚ) indicates the case to which the remaining data was normalized for each size gas passage width, D₃.

In each case, the maximum predicted value of (Eₒ*Eₚ) was associated with one of the dual blade electrode 50 or the quad blade electrode 25. Accordingly, the test data collected indicates that changing the configuration of the discharge electrode 6 increases migration velocity (ω) by a factor of two to three times nominal configurations.

One skilled in the art will recognize that the algorithm may be employed prospectively, such as during the design phase, or retrospectively, as in this case where testing of design was undertaken.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A discharge electrode for an electrostatic precipitator, comprising:
geometric features incorporated into the discharge electrode and adapted according to an algorithm for improving a collection efficiency for particles by enhancing an electric field between the discharge electrode and a collection electrode of the electrostatic precipitator.

2. The discharge electrode of claim 1, wherein the algorithm comprises a relationship:
η=1−e^{(-A/Q)ω}
wherein
η represents the collection efficiency;
ω represents a migration velocity for the particles;
A represents an area of the collection electrode; and,
Q represents the flow rate of a gas in the electrostatic precipitator.

3. The discharge electrode of claim 2, wherein the migration velocity is defined by:
ω=(EₒEₚa)/(2πh)
wherein
ω represents the migration velocity of the particles;
Eₒ represents a charging electric field;
Eₚ represents a collecting electric field;
a represents the size of the particles;
π represents a constant, pi; and,
h represents the viscosity of the gas.

4. The discharge electrode of claim 3, wherein the charging electric field is defined as:
Eₒ=Average(\sqrt{Eₓ²+E_{y}+E_{z}²})
where:
Eₓ represents the average electric field in the X direction;
E_{y} represents the average electric field in the Y direction;
E_{z} represents the average electric field in the Z direction; and,
Average represents the average value of the electric field over the entire space between the discharge electrode and the collecting plates.

5. The discharge electrode of claim 3, wherein the collecting electric field is defined as:
Eₚ=Average((|E_{y}|)
where:
E_{y} represents the average electric field in the Y direction.

6. The discharge electrode of claim 1, comprising one of a dual blade electrode, a quad blade electrode, an angle configuration electrode, a star configuration electrode, an aero configuration electrode, and a roll formed configuration electrode.

7. The discharge electrode of claim 6, wherein at least one surface of the discharge electrode comprises a sharpened edge.

8. The discharge electrode of claim 1, comprising one of a quad pin electrode and a V-Pin electrode.

9. The discharge electrode of claim 8, wherein at least one pin of the discharge electrode comprises a sharpened point.

10. The discharge electrode of claim 1, wherein the geometric features further enhance the electric field between the discharge electrode and a stiffener of the electrostatic precipitator.

11. A method for producing a discharge electrode for an electrostatic precipitator, the method comprising:
selecting an algorithm for evaluation of the collection efficiency of the electrostatic precipitator;
incorporating geometric features into the discharge electrode according to the algorithm, wherein the geometric features improve the collection efficiency by enhancing an electric field between the discharge electrode and a collecting electrode of the electrostatic precipitator.

12. The method as in claim 11, wherein incorporating comprises at least one of retrofitting, adding and replacing.

13. The method as in claim 11, further comprising modifying other aspects of the electrostatic precipitator to enhance the electric field.

14. The method as in claim 13, wherein the other aspects comprise at least one of a size, a shape and a relative placement of a stiffener of the electrostatic precipitator.

15. The method of claim 11, wherein the algorithm comprises as inputs thereto at least one of a collection efficiency, a particle migration velocity, an area of the collecting electrode, a flow rate of a gas in the electrostatic precipitator, an average electric field across a particle migration space; a local electric field at the collecting electrode, a particle size and a viscosity of the gas.

16. An electrostatic precipitator comprising at least one discharge electrode comprising geometric features incorporated into the discharge electrode and adapted according to an algorithm for improving a collection efficiency for particles by enhancing an electric field between the discharge electrode and a collecting electrode of the electrostatic precipitator.

17. The electrostatic precipitator of claim 16, wherein the discharge electrode comprises one of a dual blade electrode, a quad blade electrode, an angle configuration electrode, a star configuration electrode, an aero configuration electrode, and a roll formed configuration electrode.

18. The electrostatic precipitator of claim 16, wherein the discharge electrode comprises one of a quad pin electrode and a V-Pin electrode.

19. The electrostatic precipitator of claim 16, wherein the particles comprise at least one of a dust, a mist, fumes and a gas.
